(19) United States
(12) Patent Application Publication
(10) Pub. No.: US 2005/0276449 A1
(43) Pub. Date: Dec. 15, 2005

(54) System and method for detecting an obstruction

(76) Inventors: Didier Pedemas, Aillant Sur Milleron (FR); Thierry Pebre, Checy (FR); Chris Rhodes, Orleans (FR)

Correspondence Address: CARLSON, GASKEY & OLDS, P.C., 400 WEST MAPLE ROAD, SUITE 350, BIRMINGHAM, MI, 48009, US

(21) Appl. No.: 11/146,404

(22) Filed: Jun. 6, 2005

(30) Foreign Application Priority Data
Jun. 15, 2004 (FR) 04 06 444

(51) Int. Cl. G06K 9/00

(52) U.S. Cl. 382/104

(57) ABSTRACT

A system for detecting an obstruction in the travel of a vent, such as a window glass in an opening of a vehicle, includes a reference element. The reference element is typically coded and either visible or invisible to the naked eye or emits a light signal which extends along at least a part of the perimeter of the opening. A detector, such as a matrix camera, detects the reference element at each point of at least a part of the perimeter of the opening. The system allows detection of an obstruction in the travel of the vent, regardless of variations in light or level of contrast, improving the quality of the detection.

### REFERENCE TO RELATED APPLICATIONS

This application claims priority to French Patent Application 04 06 444 filed on Jun. 15, 2004.

### BACKGROUND OF THE INVENTION

The present invention relates generally to a system for detecting an obstruction and a method for detecting the obstruction.

Motor vehicles are commonly fitted with electrically driven window regulators. Some of the window regulators have an “express close” function which allows the window to complete all of its upward travel by a user pressing a switch just once. In this case, standards require that the travel of the window be interrupted if an obstruction is present.

Solutions have been proposed, in particular in U.S. Pat. No. 5,955,854. This document discloses an obstruction detection apparatus for windows or other types of powered aperture closures. An emitter/receiver with infrared diodes is positioned near the lower front corner of the window. When an obstruction exists above the window, an increase in reflected energy indicates the detection of an obstruction.

U.S. patent application Ser. No. 2003/0218542 discloses a protection method adopted in clamp systems in which an object, such as a door or a step, is folded down. The method proposes using a camera which takes shots of the opening which is to be obstructed by the object. The shots are regularly compared to reference images of the opening. If there is a difference synonymous with the presence of an obstruction, the movement of the object is interrupted.

The drawback of these solutions is that the variations in the level of light and contrast make it difficult to reliably detect the presence or otherwise of an obstruction based on the information received. This is particularly the case in a moving car which enters an area of alternating shadow and light (for example, between trees), where several unpredictable changes from shadow to light can occur per second.

Moreover, a standard camera has an effective resolution which is higher near the camera than at a distance. A camera will therefore be chosen that has a resolution that allows an obstruction to be effectively be detected at a distance, rather than a camera which allows detection requirements to be satisfied in an ordinary way. Consequently, the camera chosen and therefore the detection system are costly.

There is therefore a need for an effective and less costly detection system

### SUMMARY OF THE INVENTION

The present invention provides a system for detecting an obstruction in the travel of a vent in an opening of a vehicle including a reference element which extends along at least a part of a perimeter of the opening and a detector which detects the reference element at each point of at least the part of the perimeter of the opening.

According to one embodiment, the reference element is a coded segment. According to another embodiment, the coding of the reference element is invisible to the naked eye.

According to another embodiment, the coding is a space coding. For example, the coding is achieved by differentiating between colors, type of surface, or the shape of the segment.

According to another embodiment, the system also includes a light source which is visible or invisible to the naked eye and that can be frequency-coded or time-coded to illuminate the perimeter of the opening. According to another embodiment, the reference element is a segment emitting a light signal detected by the detector. According to another embodiment, the signal emitted by the reference element is time-coded or frequency-coded. According to another embodiment, the reference element extends over at least 50 mm of the perimeter of the opening. According to another embodiment, the detector is a matrix camera with a matrix of at least 8×8 pixels.

According to another embodiment, the reference element is created in a trim (such as a peripheral seal) of the perimeter of the opening, mounted on the opening, created on the vent itself or another trim of the vent or mounted on one or the other of these.

According to another embodiment, the detector is able to detect the reference element almost simultaneously at each point of the area to be protected which includes at least a part of the perimeter. One point corresponds to a unit of at least 0.5 mm long along the perimeter.

According to another embodiment, the system also includes a filter that modifies the distribution of the light rays emitted by the light source or modifies the intensity of the rays received by the detector. According to another embodiment, the filter is a lens coupled to the matrix-camera detector, and each point of the perimeter corresponds substantially to an equal number of pixels of the camera.

The invention also relates to a method for detecting an obstruction in the travel of a vent in an opening including the steps of detecting an obstruction when a detector does not detect a reference element at each point of an area to be protected. The reference element is part of a perimeter of an opening corresponding to the area being protected.

According to one embodiment, detection of the reference element by the detector occurs almost simultaneously at each point of the area to be protected which includes at least a part of the perimeter of the opening.

### BRIEF DESCRIPTION OF THE DRAWINGS

Other characteristics and advantages of the invention will become apparent when reading the following detailed description of embodiments of the invention, given by way of example only in which:

FIG. 1 shows a view of a detection system on a vehicle door.

### DETAILED DESCRIPTION OF PREFERRED EMBODIMENTS

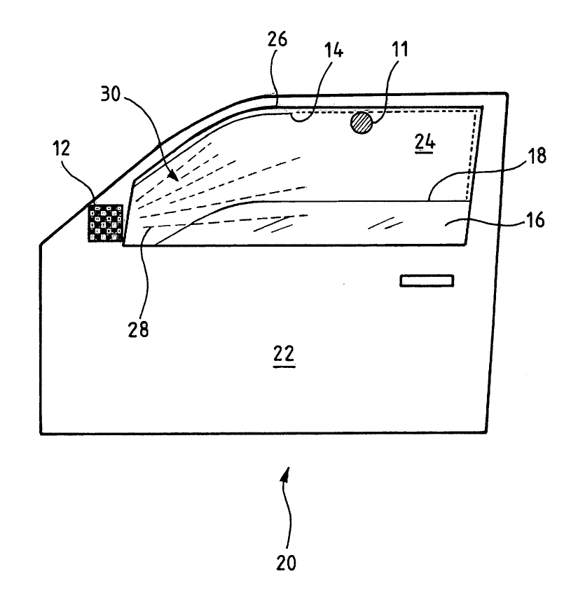

FIG. 1 shows a system 10 for detecting an obstruction 11 in the travel of a vent, such as a window 16. The system 10 includes a detector 12 and a reference element 14. The reference element 14 extends over at least a part of a perimeter of an opening 24. The reference element 14 can be detected by the detector 12 at each point of at least a part of the perimeter of the opening 24. Thus, the obstruction 11 in the travel of the window 16 which hides the reference element 14 is able to be detected regardless of the variations of light or of the level of contrast, improving the quality of detection. This is particularly advantageous for anti-pinch systems, allowing a person to be better protected against the risk of pinching. Detection is also easily achieved.

The vent is a pane or panel which closes the opening 24 of a vehicle. The vent is, for example, a window 16, such as in the drawing, or a sun roof. In the rest of the description, the window 16 will represent the vent in a non-limitative way. The window 16 can move over a course of travel between a lowered position and a raised position. An upper edge 18 of the window 16 is represented in a position near the lowered position where the window 16 is fully open.

A door 20 of a motor vehicle is also represented schematically. It may be a front or back door. The figure shows a lower part 22 of the door 20, as well as the opening 24 created by the window 16 moving downwards. The upper edge 18 of the window 16 is represented in FIG. 1 near a position where it is completely withdrawn into the lower part 22. The window 16 is actuated by an electric window regulator in the lower part 22. An upper perimeter 26 of the opening 24 is also represented. The upper perimeter 26 can be that of the frame of the door 20. However, the door 20 can also be frameless, and the upper perimeter 26 can then be the roof of the vehicle which the window 16 enters in its raised position. The upper perimeter 26 is, for example, the seal of the frame, the roof or the slide which the window 16 enters in the raised position to seal the passenger compartment. The danger is that the obstruction 11 is pinched between the upper edge 18 of the window 16 and the upper perimeter 26 when the window 16 is raised.

FIG. 1 also shows the detector 12. The detector 12, in the example in FIG. 1, is positioned at the lower front corner of the opening 24, which substantially corresponds to the attachment point of a rear view mirror. The detector 12 “watches” a more or less vertical angular area or an angular sector 30. The angular sector 30 covers the part of the opening 24 which is bounded by the upper perimeter 26 and by a straight line 28 from the detector 12. In other words, the detector 12 covers, in the plane of the opening 24 or in the plane of the window 16, an area near the upper perimeter 26. This area is the one in which pinching is to be detected, and it is not necessary to detect the presence of an obstruction 11 near the lower perimeter of the opening 24. This zone corresponds to the zone to be protected and includes at least a part of the perimeter of the opening 24. It can be envisioned that the detector 12 configuration is such that at least 50 mm are covered by the detector 12 in the direction of travel of the window 16 before the upper perimeter 26 is reached. The upper perimeter 26 is formed by the window seal in the example in FIG. 1. The angle of the angular sector 30 therefore depends on the position of the detector 12. Alternatively, the detector 12 is situated in an upper part of the opening 24 and detects the reference element 14 on the lower perimeter of the opening 24, for example along the sealing strip of the window 16. Another solution is that the detector 12 sees or watches the entire perimeter of the opening 24. Detection is thus ensured over the entire opening 24. Two or more detectors 12 can also be used instead of the single detector 12 represented in FIG. 1.

The detector 12 is, for example, a matrix-type camera. This type of camera enables more precise and easier detection. The resolution of the camera is chosen on the basis of the size of object to be detected. The detector 12 recognizes the reference element 14 by allocating one or more pixels to one or more points of the reference element 14. When the points no longer correspond to the pixels, for example because the reference element 14 is hidden by an obstruction 11, the detector 12 no longer recognizes the reference element 14, and a signal indicating the presence of an obstruction 11 is emitted. Preferably, the resolution of the camera is chosen according to the size of the object so that the object can be reliably detected. The camera matrix is at least 8 pixels wide by 8 pixels high, i.e., 8×8 pixels. In one embodiment, a camera with a resolution of 300×600 pixels is used. The camera is positioned vertically as represented in FIG. 1 and points towards the opening 24.

The reference element 14 is suited and designed to be detected by the detector 12. The reference element 14 is such that it is recognized by the detector 12, “watching” the area to be protected. Detection occurs at each point of at least a part of the perimeter of the opening 24. Thus, detection of the obstruction 11 by the detector 12 occurs over a chosen portion of the perimeter where there is a risk of pinching. Detection can occur over all or part of the upper perimeter 26. Thus, the detector 12 is able to “watch” the entire perimeter, particularly along the lower perimeter of the opening 24. Detection by the detector 12 occurs at each point so that detection is effective along the entire length of the perimeter to be protected. The length to be protected can correspond to that occupied by the reference element 14. Detection at each point means the individual detection by the detector 12 of units of length along the perimeter of the opening 24. Regardless of the nature of the detector 12 and the detection, a point corresponds, for example, to a unit at least 0.5 mm, preferably 2 mm, long along the perimeter.

The reference element 14 can be a longitudinal element extending over at least part of the perimeter of the opening 24. The reference element 14 extends, for example, over at least 50 mm of the perimeter of the opening 24. The reference element 14 can be an inert body detected by the detector 12. As long as the inert body is recognized by the detector 12, the window 16 continues to move, enabling less expensive detection.

Detection by the detector 12 advantageously occurs almost simultaneously. The detector 12 detects each point of a perimeter on which detection is desired almost simultaneously. Almost-simultaneous detection by the detector 12 is more effective than detection by scanning. In the case of scanning, the detector 12 monitors the entire area in succession. By contrast, in the case of almost-simultaneous detection at each point, all of the area to be monitored is under surveillance at practically the same time, reducing the time during which points are momentarily not under surveillance. The risk of pinching is thus reduced. A matrix-camera detector 12 facilitates almost-simultaneous detection at each point. Pixels of the camera are allocated to each point of the perimeter to be detected. A camera with a bigger matrix allows surveillance over a larger area and thus more accurate surveillance.

The reference element 14 is, for example, a coded segment. The detector 12 recognizes the coding of the reference element 14 when there is no obstruction in the travel of the window 16. By contrast, when there is an obstruction 11 in the travel of the window 16, the obstruction 11 blocks the segment and disturbs the coding allowing the detector 12 to detect the disturbance. The segment can be space-coded, and this is achieved, for example, by differentiating between colors, types of surface or shapes of the segment. For example, the reference element 14 includes a sequence of black and white bars distributed in a way which is recognizable to the detector 12. One or more pixels of the detector 12 in the form of a matrix-type camera are allocated to recognize one or more points of the reference element 14, i.e., white or black areas. When an obstruction 11 hides at least one of these bars, the allocation between the pixels and the points of the reference element 14 differs from that usually recognized by the detector 12, allowing the system to detect the presence of an obstruction 11. The coded segment is chosen so that an obstruction 11 present in the opening 24 upsets the sequencing of the code. In other words, a sufficiently precise code is chosen for detection of the code by the detector 12 to be disturbed by the obstruction 11. Thus, in the case of a coded segment in the form of a bar code, the space between bars is smaller than the size of the smallest obstruction to be detected. For example, to ensure the detection of the little finger of a hand, the space between the bars is less than the width of this finger. Thus, the little finger necessarily hides at least one bar, which is detected by the detector 12. The little finger cannot “fall” between two bars, which would not have made its presence detectable. This makes detection more certain. In practice, the obstruction 11 is not stationary and so its movements hide several bars.

The coded segment is, for example, a 5 mm wide strip in a direction transverse to the plane of the window 16 or to the plane of the opening 24. The detector 12 thus advantageously covers the angular sector 30 with a “thickness” at least equal to the width required to see the entire coded segment. The detector 12 may however be able to detect an angular sector 30 of greater thickness, for example of 4 to 5 cm, corresponding to the width required to see the entire width of the seal of the perimeter of the opening 24. The thickness of the angular sector 30 detected by the detector 12 can be centered on the plane of the window 16.

The reference element 14 can be invisible to the naked eye, or in any case hard to see with the naked eye, allowing the coded segment to be used more discretely. The reference element 14 can be created in a trim, such as a peripheral seal, of the perimeter of the opening 24. Preferably, the reference element 14 is embedded in the seal. Alternatively, the reference element 14 can be created on the window 16 itself or another trim of the window 16 or mounted on one or the other of these. This protects the reference element 14 against the risk of being pulled off. The seal can thus be produced and mounted directly on the reference element 14, which avoids subsequent mounting of the reference element 14.

A light source can also be provided to improve detection of the obstruction 11 by the detector 12. It is advantageous to use a light source with infrared or ultra violet radiation. Such a light source has the advantage that it does not disturb the passengers of the vehicle or the driver. Moreover, as stated above, the detector 12 is sensitive to infrared radiation. The light source can be a single or a distributed light source, depending on the nature and position of the detector 12. The light emitted by the light source is also preferably prevented from directly reaching the detector 12. One solution includes positioning the light source close to the detector 12.

Moreover, the reference element 14 can be an element which itself emits a continuous signal or a time-coded and/or a frequency-coded signal. It can be a light signal. The light signal is easily recognized by the detector 12, in different environmental conditions. The reference element 14 is, for example, an optical fiber which is treated to emit light (including infrared or ultraviolet light) along its entire length. A light source at one end of the fiber can be controlled by the system which controls the detector 12.

To improve the detection of the reference element 14 by the detector 12, a lens may be coupled to the detector 12. The lens is interposed in the field of view of the detector 12. The lens makes it possible to increase the area of the perimeter of the opening 24 to be monitored which is the furthest from the detector 12. The lens is, for example, of the progressive type. In the case of a matrix-camera type detector, the lens allows the number of pixels of the camera to be optimized depending on the distance between the detector 12 and the points to be detected. In other words, because of the lens, each point corresponding to a unit of length along the perimeter of the opening 24 corresponds substantially to a set number of pixels on the detector 12, regardless of the distance between the detector 12 and the points to be detected. As a result, the detection system may have a camera with a lower resolution, but provide the same resolution at any point round the perimeter.

Moreover, a distributing filter modifying the distribution of the light rays from the light source can also be used around the entire perimeter of the opening 24. The filter can also modify the intensity of the light rays received by the detector 12. The filter distributes the light around the entire perimeter so that no matter what the distance between the detector 12 and the points to be monitored on the perimeter, the light received by the detector 12 is the same. For example, the filter is placed in the path of the light rays produced by the light source. The filter subdues the intense light rays from an area near the detector 12 and the source, but does not subdue the less intense light rays from an area far from the detector 12 and the light source. The filter is, for example, darker to subdue the more intense rays and lighter not to subdue the less intense rays. Alternatively, the filter is placed in the field of detection of the detector 16 to filter the light rays which are reflected and which reach the detector 12.

Advantageously, the lens described previously performs the functions of a filter. This avoids using a filter and thus simplifies the detection system. The lens has the characteristics of the filter described previously. The lens can thus be partially darkened to filter some of the rays. More generally, the lens compensates for the variations in distance and angle of incidence between the points of the perimeter to be detected and the light source or the detector 12.

The method for detecting an obstruction 11 can be implemented simply by detecting the reference element 14. When the detector 12 no longer detects the reference element 14 at each point of at least a part of the perimeter of the opening 24, a signal is emitted, indicating the presence of an obstruction 11. The absence of detection is due to the obstruction 11 at least partly hiding the reference element 14. The reference element 14 is an index which can be easily located by detector 12. As long as the detector 12 recognizes the reference element 14, no obstruction blocks the opening 24. Detection of the reference element 14 by the detector 12 occurs almost simultaneously at each point of the area to be protected which comprises at least a part of the perimeter of the opening 24. This avoids recourse to scanning the area to be protected, as explained above.

The detection system can use algorithms to recognize the reference element 14. Moreover, the reference element 14 is easy to recognize, allowing a simple algorithm for shape recognition to be used. The detection system is thus less costly. The detection system's location method does not work by locating obstructions for which different algorithms are used, but rather works by a disturbance in the location of the reference element 14 which has a known shape. The disturbance of recognition of the reference element 14 by the detector 12 due to the presence of an obstruction 11 is synonymous with the presence of an obstruction 11. Recognition is disturbed when the detector 12 no longer detects the entire reference element 14. The detector 12 no longer detects the entire reference element 14 when at least a part of the reference element 14 is hidden by the obstruction 11. Detection of the obstruction 11 results from a binary (two-state) signal which rapidly indicates whether an obstruction is or is not present. When an obstruction 11 is detected, the movement of window 16 is interrupted, or preferably reversed. This allows pinching of the obstruction 11 to be avoided, in particular if the obstruction 11 is, for example, a hand or a neck.

Of course, the present invention is not limited to the embodiments described by way of example. Thus it may be envisioned that the lens can be used independently of the reference element 14. Generally, the lens can be used in an obstruction 11 detection system which uses a light source in order to detect the obstruction even in the case of unfavorable natural light.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A system for detecting an obstruction in a path of travel of a vent in an opening of a vehicle comprising:
a reference element which extends over at least a part of a perimeter of the opening; and
a detector which detects the reference element at each point of the at least a part of the perimeter of the opening.

2. The system according to claim 1, wherein the reference element is a coded segment.

3. The system according to claim 2, wherein the coded segment is invisible to the naked eye.

4. The system according to claim 2, wherein the coded segment is space coded.

5. The system according to claim 4, wherein the coded segment is achieved by differentiating between one of a color, a type of surface and a shape of the coded segment.

6. The system according to claim 1, further including a light source which is either visible or invisible and frequency-coded or time-coded to illuminate the perimeter of the opening.

7. The system according to claim 1, wherein the reference element is a segment emitting a light signal detected by the detector.

8. The system according to claim 7, wherein the light signal emitted by the reference element is time-coded or frequency-coded.

9. The system according to claim 1, wherein the reference element extends over at least 50 mm of the perimeter of the opening.

10. The system according to claim 1, wherein the detector is a matrix camera with a matrix of at least 8×8 pixels.

11. The system according to claim 1, wherein the reference element is one of created in a trim of the perimeter of the opening, mounted on the trim of the perimeter of the opening, created on the vent, mounted on the vent, created on another trim of the vent and mounted on the another trim of the vent.

12. The system according to claim 1, wherein the detector detects the reference element almost simultaneously at each point of an area to be protected which includes the at least a part of the perimeter, and one point corresponds to a unit of at least 0.5 mm long along the perimeter.

13. The system according to claim 1 further including a filter that modifies a distribution of light rays emitted by a light source or modifies an intensity of the light rays received by the detector.

14. The system according to claim 13, wherein the reference element is one of created in a trim of the perimeter of the opening, mounted on the trim of the perimeter of the opening, created on the vent, mounted on the vent, created on another trim of the vent and mounted on the another trim of the vent.

15. The system according to claim 14, wherein the detector is a matrix camera and the filter is a lens coupled to the matrix camera, and each point of the perimeter corresponds substantially to an equal number of pixels of the matrix camera.

16. A method for detecting an obstruction in a path of travel of a vent in an opening, the method comprising the steps of:
detecting a reference element at each point of an area to be protected with a detector, wherein the reference element is on a part of a perimeter of an opening that corresponds to the area to be protected; and
detecting an obstruction when the detector does not detect the reference element at each point of the area to be protected.

17. The method according to claim 15, wherein the step of detecting the reference element by the detector occurs almost simultaneously at each point of the area to be protected, wherein the area includes at least the part of the perimeter of the opening.
